(19) United States
(12) Patent Application Publication
(10) Pub. No.: US 2017/0038329 A1
(43) Pub. Date: Feb. 9, 2017

(54) High-Pressure Reference Electrode for Application in Systems Containing High-Pressure Gases

(71) Applicants: Lietai Yang, San Antonio, TX (US); Xiaodong Sun Yang, San Antonio, TX (US)

(72) Inventors: Lietai Yang, San Antonio, TX (US); Xiaodong Sun Yang, San Antonio, TX (US)

(21) Appl. No.: 14/819,481

(22) Filed: Aug. 6, 2015

(51) Int. Cl. G01N 27/30

(52) U.S. Cl. CPC G01N 27/301

(57) ABSTRACT

When a pressure-balanced reference electrode is exposed to a system containing a high-pressure gas (such as CO₂, N₂, or H₂), a large amount of the gas diffuses into the inner compartment housing the internal reference electrolyte. The large amount of gas has a high pressure and may expand the inner compartment and cause mechanical damage to the inner compartment when the pressure surrounding the reference electrode is suddenly reduced. This invention is related to the reference electrodes that have a pressure-relief mechanism. When the surrounding pressure suddenly drops, such electrodes are not subject to the damage by the expansion of the high-pressure gases trapped in the inner compartment.

### TECHNICAL FIELD OF THE INVENTION

This invention relates to pressure-balanced reference electrodes for applications in systems containing high-pressure gases.

### BACKGROUND OF THE INVENTION

Pressure-balanced reference electrodes are widely used for corrosion control and electrochemical studies (see U.S. Pat. No. 4,273,637 to D. D. Macdonald, et al.) Pressure-balanced electrodes are also used for pH measurements in systems containing high-pressure gases [see H. Shao, et al. “Dissolution and Precipitation of Clay Minerals under Geologic CO₂ Sequestration Conditions: CO₂-Brine-Phlogopite Interactions,” Environ. Sci. Technol., 2010, 44 (15), pp. 5999-6005]. However, the depressurization rate must be limited to an extremely low value (about 5 bar/hour) after the reference electrode has been exposed to a high-pressure gas to avoid failure of the reference electrode. This is because the pressure-balanced reference electrode has an internal electrolyte contained in an inner compartment formed with a plastic membrane that is usually permeable to gases. When the reference electrode is exposed to a system containing high-pressure gases (such as CO₂, N₂, or H₂), a large amount of the gases diffuse though the membrane and dissolve into the internal electrolyte. The large amount of gases may expand the inner compartment and cause mechanical damage to the inner compartment when the pressure surrounding the reference electrode is suddenly reduced because the gases with high partial-pressure inside the inner compartment cannot diffuse out of the compartment quickly enough and there is a large pressure difference between the inside and outside of the inner compartment.

This invention is related to the reference electrodes that have pressure-relief mechanisms. When the electrodes experience a sudden pressure reduction, such electrodes are not subject to the damage by the expansion of the gases trapped in the inner compartment.

### BRIEF DESCRIPTION OF THE DRAWINGS

FIG. 1 illustrates a typical high-pressure reference electrode that has a pressure-relief plug that automatically opens and lets the internal fluids out when the pressure of the external liquid is suddenly lower than the pressure in the inner compartment.

FIG. 2 illustrates a variation of the high-pressure reference electrode that has a pressure-relief plug that automatically opens and lets the internal fluids out when the pressure of the external liquid is suddenly lower than the pressure in the inner compartment.

FIG. 3 illustrates a typical high-pressure reference electrode that has a pressure-relief cap that automatically let the internal fluids out when the pressure of the external liquid is suddenly lower than the pressure in the inner compartment.

FIG. 4 illustrates a typical high-pressure reference electrode with a second compartment outside of the flexible internal compartment. The second compartment is expandable when the pressure of the external liquid is lower than the pressure in the inner compartment.

FIG. 5 illustrates a typical high-pressure reference electrode with a second compartment outside of a rigid inner compartment. The second compartment is expandable when the pressure of the external liquid is lower than the pressure in the inner compartment.

FIG. 6 illustrates a high-pressure reference electrode that has a pressure-relief plug that automatically opens and lets the internal fluids out when the pressure of the external liquid is suddenly lower than the pressure in the inner compartment. The inner compartment has an inlet that allows a metering pump to continuously feed the internal electrolyte.

FIG. 7 illustrates a high-pressure reference electrode that has a pressure-relief cap that automatically lets the internal fluids out when the pressure of the external liquid is suddenly lower than the pressure in the inner compartment. The inner compartment has an inlet that allows a metering pump to continuously feed the internal electrolyte.

FIG. 8 illustrates a typical high-pressure reference electrode with an inlet on the internal compartment and a second compartment made of an elastic material outside of the internal compartment. The inlet allows fresh internal electrolyte to flow continuously through the internal compartment and keep the high-pressure gases from reaching the internal compartment. The second compartment automatically expands to contain the excess internal electrolyte so that it will not flow out of the reference electrode to contaminate the external liquid.

FIG. 9 illustrates a typical high-pressure reference electrode with an inlet on the internal compartment and a second compartment made of a foldable material outside of the internal compartment. The inlet allows fresh internal electrolyte to flow continuously through the internal compartment and keep the high-pressure gases from reaching the internal compartment. The second compartment automatically unfolds to contain the excess internal electrolyte so that it will not flow out of the reference electrode to contaminate the external liquid.

### REFERENCE NUMBERS OF DRAWINGS

3 tubing for connecting a metering pump (see 8) to the inlet of the inner compartment (see 6)
5 metal conductor connected to reference material (see 35)
6 inlet of inner compartment (see 70)
8 metering pump
15 seals for reference electrode
19 top nut of high-pressure fitting
20 high-pressure fitting
21 bottom nut of high-pressure fitting
22 seal for connection to metal tubing (see 33)
23 thread for mounting electrode to a pressurized system
30 inner compartment for housing internal electrolyte, usually made of a flexible polytetrafluoroethylene (PTFE) tube, but can also be made of a rigid material (see 31)
31 rigid housing material of inner compartment for housing internal electrolyte, usually made of a ceramic tube
33 probe body that facilitates installation of the electrode to a high-pressure vessel and forms the pressure boundary
35 reference material (usually Ag/AgCl)
40 pressure relief port (hole)
45 pressure relief plug that electrically isolates the internal electrolyte (see 70) from the external liquid (see 90) when closed
50 pressure-relief cap formed with an elastic tube that electrically isolates the internal electrolyte (see 70) from the external liquid (see 90), but lets the internal fluids out when there is a pressure difference between the inside and the outside of the inner compartment.
60 elastic ring that keeps the pressure-relief plug (45) closed during normal operation, but allows the plug to open when there is a pressure difference between the inside and the outside of the inner compartment
70 internal electrolyte for reference electrode (usually KCl solution)
83 upper seal between the wall of the inner compartment (30) and second compartment (see 85)
85 second compartment for holding the fluids from the inner compartment
86 elastic membrane of the second compartment that is expandable to allow the fluids in the inner compartment to escape and to be stored in the second compartment when there is a pressure difference between the inside and the outside of the inner compartment. The elastic membrane pushes the fluids back to the inner compartment when the pressure difference disappears
87 foldable membrane of the second compartment that allows its volume to increase by unfolding to store the fluids from the inner compartment
88 lower seal between the wall of the inner compartment wall (30) and second compartment (85)
90 external liquid in which the electrode is used (immersed) liquid-junction plug that electrically connects the internal electrolyte (70) with the external liquid (90)
95 high-pressure vessel

### DETAILED DESCRIPTIONS OF THE INVENTION

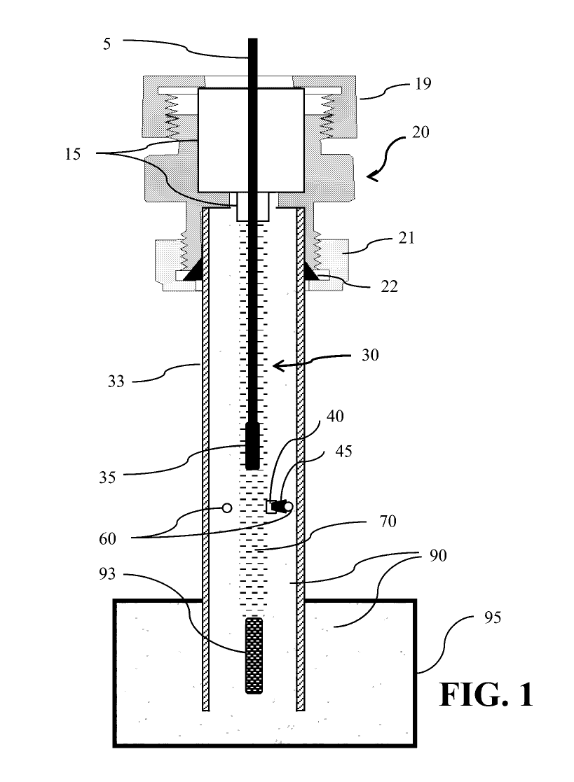

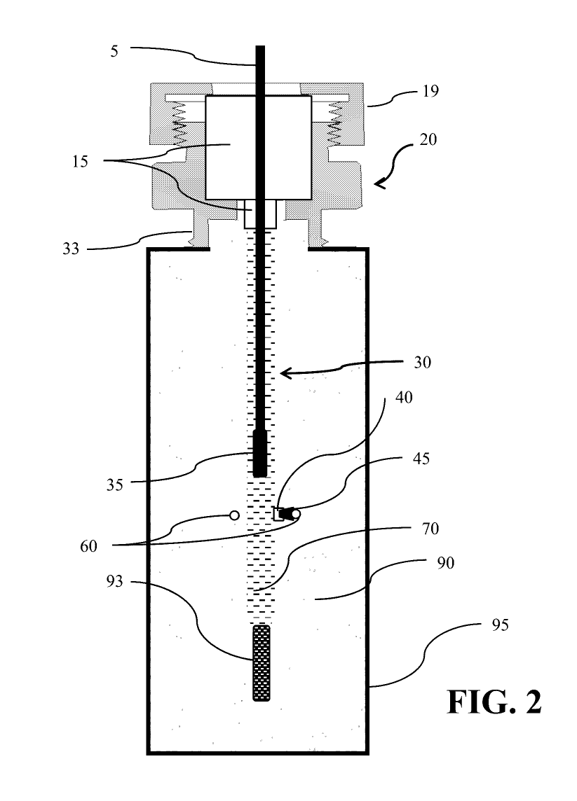

### FIG. 1 and FIG. 2

FIG. 1 shows a typical high-pressure reference electrode that has a pressure-relief port and a plug. The reference material (35) and the internal electrolyte (70) of the reference electrode are inside the inner compartment (30). The electrical lead (5) that is connected to the reference material (35) and the internal electrolyte (70) is sealed inside the inner compartment with the seals (15) and the high-pressure fitting (20). The high-pressure fitting has a nut (21) and a metal seal (22) that are used to assemble the electrode to a probe body (33) that facilitates the mounting of the reference electrode to a high-pressure vessel (95) that contains the external liquid (90) in which the reference electrode is used.

In addition, there is a liquid-junction plug (93). The function of the junction plug (93) is to retain the internal electrolyte (70) inside the inner compartment while maintaining an ionic conducting path between the internal electrolyte (70) and the external liquid (90). The inventors have successfully used the tip section of a commercial reference electrode (cut off from the body of the electrode) as the inner plug. This tip section had a ceramic plug (approximately 1 mm in diameter) inside a glass casing (approximately 4 mm in outside diameter), with a total length of about 4 mm. (The commercial reference electrode was supplied by Broadley-James Corp., Irvine, Calif., USA).

The wall of the inner compartment (30) is usually made of a flexible membrane such as polytetrafluoroethylene (PTFE) tube that allows the pressure inside the inner compartment (30) to be equal to the pressure of the external liquid (90) under normal conditions to minimize the inter-mixing of the external liquid with the internal electrolyte through the liquid-junction plug by any pressure difference. For this reason, this type of electrodes is called pressure-balanced reference electrode. The intermixing is undesirable because the moving of the external liquid (90) into the internal compartment (30) causes the contamination of the internal electrolyte (70) and the excessive moving of the internal electrolyte (70) to the external liquid (90) causes the loss of internal electrolyte.

When a reference electrode has been exposed to a high-pressure vessel (95) containing high-pressure gases (such as CO₂, N₂, or H₂), a large amount of the gases diffuse though the wall of the inner compartment (30), driven by the differences of the partial pressure of the gases (even when the total pressure inside the inner compartment is equal to the total pressure outside of the inner compartment), and dissolve into the internal electrolyte. At the end of each experiment, the pressure of the high-pressure vessel must be decreased to change out the solution for a new experiment. In addition, pressure fluctuation is often unavoidable in some experiments or in certain industrial processes. In conventional pressure-balanced reference electrode (see U.S. Pat. No. 8,377,276 to L. Yang et al.), there is no pressure-relief port (40). The large amount of gases would expand the inner compartment (30) and cause a mechanical damage to the inner compartment when the pressure surrounding the inner compartment (the vessel pressure) is suddenly reduced because the gases with high partial-pressure cannot diffuse out of the inner compartment fast enough. In the present invention, the pressure-relief plug (45) will be pushed open by the high-pressure gases in the inner compartment (30) whenever the pressure of the external liquid is suddenly substantially lower than the pressure of the high-pressure gases in the inner compartment (30). The pressure-relief plug is held in the closed position by the elastic ring (60) when the pressure difference between the inside and the outside is less than a threshold value that would not cause any damage to the inner compartment. The pressure-relief plug is made of a soft rubber and forms a good seal with the surface of the pressure-relief port to maintain a low ionic conductance between the internal electrolyte (70) and the external liquid (90). The pressure-relief port (40), the pressure-relief plug (45), and the elastic ring (60) together forms a check value that lets high-pressure fluid [internal electrolyte and the high pressure gas(es)] out when there is a pressure difference, but keeps the internal electrolyte isolated from the external liquid during normal conditions. The elastic ring (60) can also be replaced by a spring-loaded mechanism to keep the pressure-relief plug (45) closed when the inside pressure is close to the outside pressure.

Because the internal electrolyte is carried out by the high-pressure gas(es) into the external liquid (90) every time there is a sudden pressure drop, such electrodes may not be functional after experiencing a sudden pressure drop. It must be must be refilled with new internal electrolyte (70) before it can be reused.

In addition, if the external liquid is sensitive to the contamination by the internal electrolyte (70), the external liquid must be replaced with new external liquid (90)

FIG. 2 shows a variation of the high-pressure reference electrode as shown in FIG. 1. In FIG. 2, the high-pressure fitting (20) and the probe body (33) are made of one piece of metal and mounted on to the high-pressure vessel (95) directly.

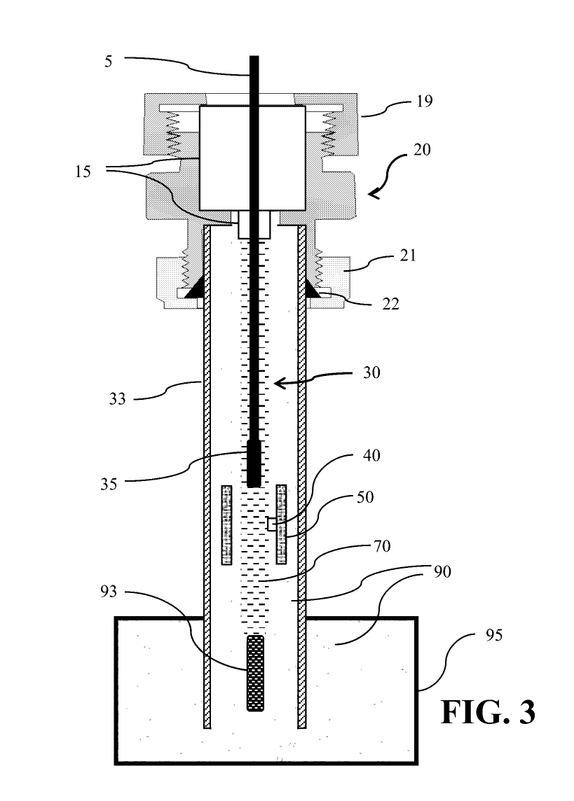

### FIG. 3

FIG. 3 shows another variation of the reference electrode as shown in FIG. 1. In FIG. 3, the pressure-relief plug (45) and the elastic ring (60) of FIG. 1 are replaced by a pressure-relief cap (50) which is formed with an elastic rubber tube. Because of its elastic property, the pressure-relief cap (50) tightly holds on to the pressure-relief port and electrically isolates the internal electrolyte (70) from the external liquid (90) when the pressure of the internal electrolyte is close to that of the external liquid, but lets the fluids in the inner compartment out when the pressure of the internal electrolyte is higher than that of the external liquid.

The inventors had tested a pressure-relief cap made of a rubber tube with a wall thickness of about 1.5 mm and an inside diameter about 4 mm over an inner compartment made of a PTFE tubing (5 mm outside diameter). When the difference between the inner compartment pressure and the external liquid pressure was less than 1 bar, the pressure-relief cap tightly held on to the pressure-relief port as evidenced by the high impedance (greater than 1 Mohm) between the metal conductor and the metal high-pressure vessel when measured with an alternating current (AC) of 2.95 V. It was observed that the internal liquid was squeezed out of the inner compartment when the inner compartment pressure was higher than the external liquid pressure by 7 bar, which did not damage the inner compartment.

It was also observed that the internal electrolyte was squeezed out of the inner compartment through the pressure-relief port after the inner compartment pressure was suddenly higher than the external liquid pressure, and the reference electrode was not functional any more afterward. Therefore, the inner compartment must be refilled after a sudden reduction of the external liquid pressure.

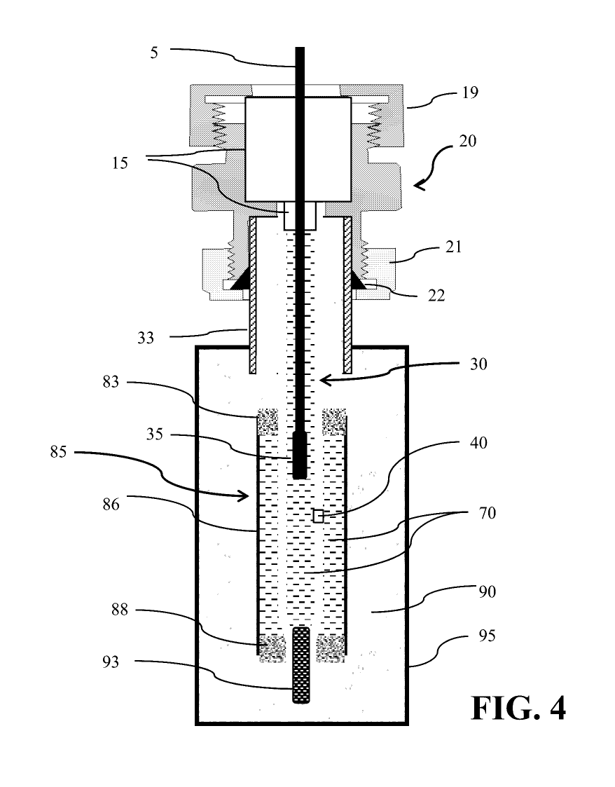

### FIG. 4

FIG. 4 illustrates a typical high-pressure reference electrode that has a second compartment (85) outside of the inner compartment (30). The second compartment (85) is connected to the inner compartment (30) by the pressure-relief port (40). The second compartment (85) is formed with an elastic material (86) that shrinks when the inside pressure is close to the outside pressure to keep the majority of the internal electrolyte (70) in the inner compartment (30) and expands when the inside pressure is substantially higher than that of the outside pressure. The volume of the expanded second compartment (85) should be such that it holds enough fluids (internal electrolyte and gases) from the inner compartment so that the pressure of the internal electrolyte will be sufficiently below the threshold value that may cause damage to the inner compartment (30). Because the total pressure in the high-pressure vessel (95) is low after a sudden pressure decrease, the gases in both the inner compartment (30) and in the second compartment (85) will slowly diffuse out into the high-pressure vessel (95). As the gases diffuse out, the inner pressure decreases and the volume of the second compartment (85) shrinks and eventually forces the remaining liquid back to the inner compartment (30). The advantage of FIG. 4 is that the second compartment (85) prevents the internal electrolyte (70) from entering and contaminating the external liquid (90). It also eliminates the need for refilling the inner compartment (30) after the reference electrode experiences a sudden pressure drop.

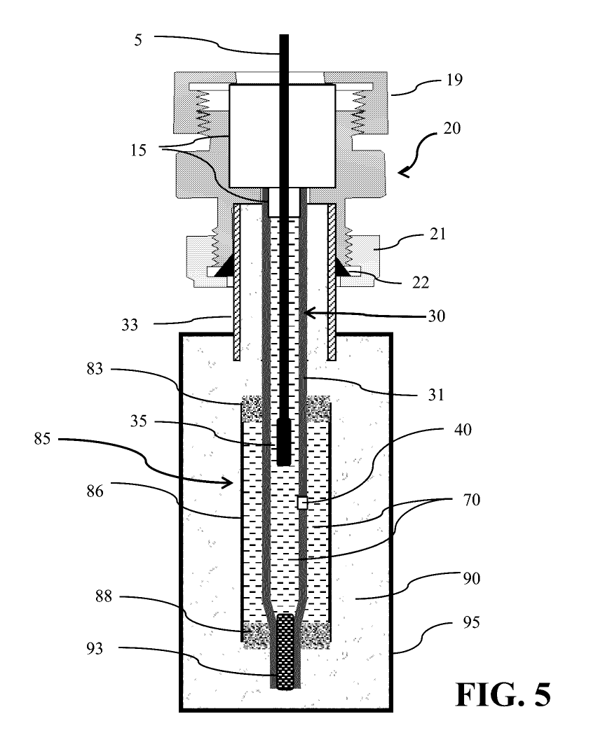

### FIG. 5

FIG. 5 shows a slight variation of the FIG. 4. In FIG. 5, the commonly-used flexible housing material of the inner compartment (30) is replaced by a rigid housing material (31). Because the second compartment (85) is made of a flexible elastic membrane (86), the reference electrode is still a pressure-balanced reference electrode because the inside pressure is always equal to the outside pressure, under normal operating conditions (except for the time when the high-pressure vessel is suddenly depressurized while the inner compartment contains high-pressure gases).

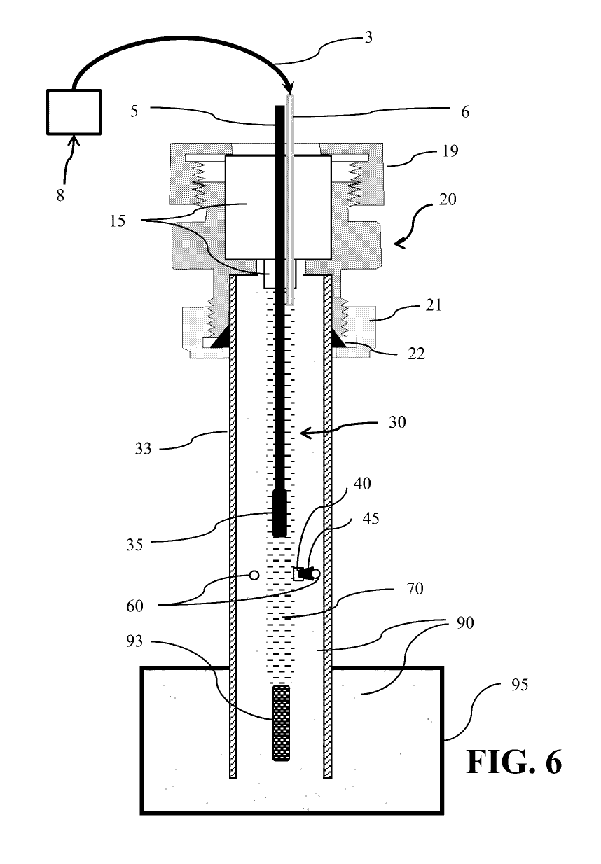

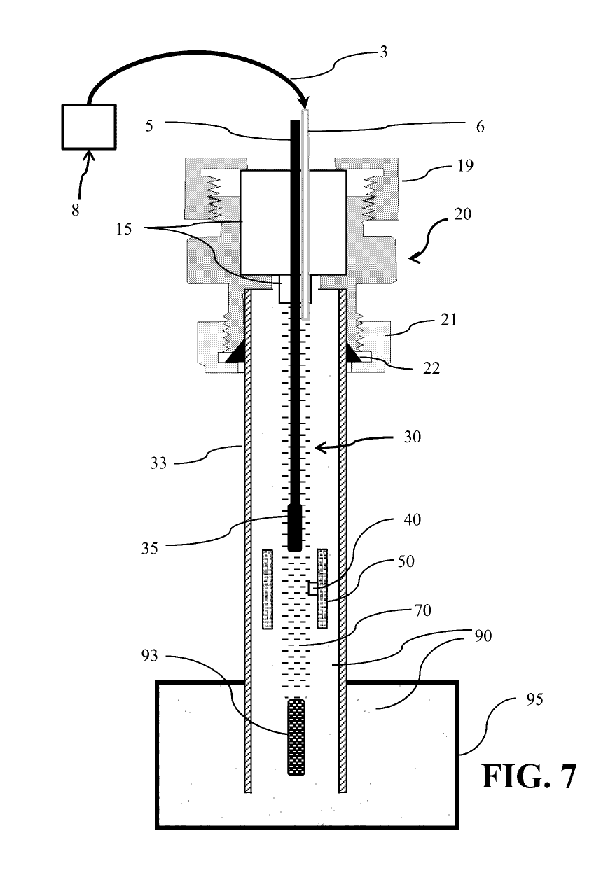

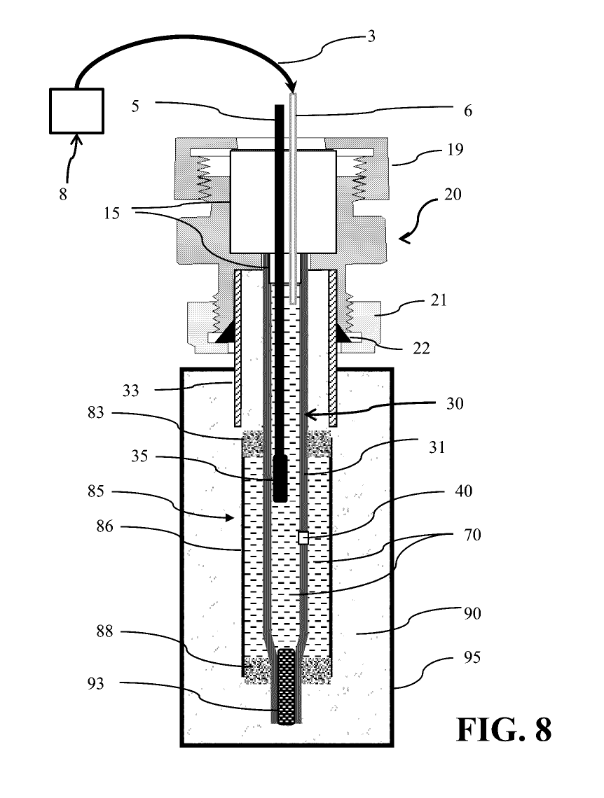

### FIG. 6, FIG. 7, and FIG. 8

FIG. 6 illustrates another variation of FIG. 1. In FIG. 6, a metering pump (8) is used to continuously introduce a small flow of fresh internal electrolyte (70) into the inner compartment (30). This flow of fresh electrolyte prevents the building-up of the high-pressure gases that enter the inner compartment through the liquid junction (93) or through the wall of the inner compartment (30) from the high-pressure vessel (95).

Like FIG.6, FIG. 7 illustrates a variation of FIG. 3. In FIG. 7, a metering pump (8) is used to continuously introduce a small flow of fresh internal electrolyte (70) into the inner compartment (30). This flow of fresh electrolyte prevents the building-up of the high-pressure gases that enter the inner compartment through the liquid junction (93) or through the wall of the inner compartment (30) from the high-pressure vessel (95).

FIG. 8 illustrates a variation of FIG. 5. In FIG. 8, a metering pump (8) is used to continuously introduce a small flow of fresh internal electrolyte (70) into the inner compartment (30). This flow of fresh electrolyte prevents the building-up of the high-pressure gases that enter the inner compartment through the liquid junction (93) from the high-pressure vessel (95). The additional volume added by the metering pump (8) enters the second compartment (85) though the pressure-relief port (40) and is confined by the second compartment (85) so that the internal electrolyte does not contaminate the external liquid.

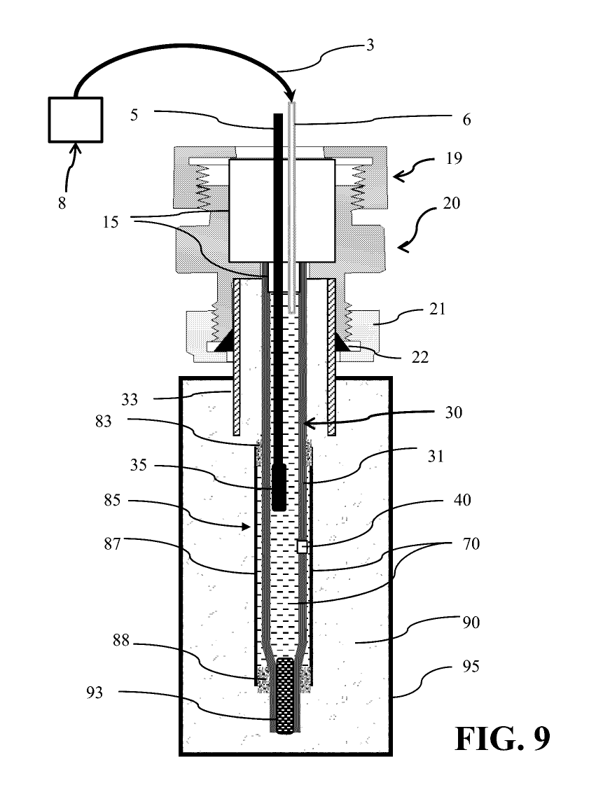

### FIG. 9

FIG. 9 illustrates a variation of FIG. 8. In FIG. 9, the elastic expandable housing membrane (86) for the second compartment (85) in FIG. 8 is replaced by a foldable membrane (87). At the start of an experiment, the second compartment (85) is empty and is in the form of folded or flatten shape like a bag made of a soft material. When the metering pump is started, the fresh internal electrolyte (70) is introduced into the inner compartment (30) and the excess internal electrolyte flows into the second compartment (85). As the volume of the internal electrolyte in the second compartment increases, the foldable membrane (87) starts to unfold, allowing more room for holding the excess internal electrolyte. The final volume of the second compartment (85) should be such that it holds enough internal electrolyte (70) introduced by the metering pump (8) at the end of an experiment.

### Other Embodiments

Although the present invention has been described in detail, it should be understood that various changes, substitutions, and alterations can be made hereto, without departing from the spirit and scope of the invention as defined by the appended claims.

1. A reference electrode for high-pressure applications, comprising:
(a) an inner compartment for housing an internal electrolyte and a metal conductor connected to a reference material at the bottom;
(b) a high-pressure probe body connected to a high-pressure vessel filled with an external liquid which may contain a high-pressure gas or a mixtures of gases that can get into the inner compartment by diffusion.
(c) seals at the top of the inner compartment that seal the internal electrolyte and the reference material inside the inner compartment and allow the metal conductor to penetrate a high-pressure fitting on top of the reference electrode's high-pressure probe body for electrical connection;
(d) a porous liquid-junction plug sealed to the bottom of the inner compartment wherein the plug forms an ionic conducting path between the internal electrolyte and the external liquid;
(e) a pressure-relief port on the wall of the inner compartment and the pressure-relief port is surrounded by the external liquid;
(f) a pressure-relief regulating component;
wherein the pressure-relief regulating component allows the gas or liquid fluids inside the inner compartment to flow out through the pressure-relief port when the inner compartment pressure is higher than the external liquid pressure by 1 bar, but keeps the internal electrolyte isolated from the external liquid when the inner compartment pressure is not higher than the external liquid pressure by 0.5 bar.

2. The reference electrode of claim 1, wherein the pressure-relief regulating component is comprised of a pressure-relief plug and an elastic ring that keeps the pressure-relief plug closed and isolates the internal electrolyte from the external liquid when the inner compartment pressure is not higher than the external liquid pressure by 0.5 bar, but allows the plug to open when the inner compartment pressure is higher than the external liquid pressure by 1 bar.

3. The reference electrode of claim 1, wherein the pressure-relief regulating component is comprised of a pressure-relief cap formed with an elastic tube that keeps the pressure-relief port covered when the inner compartment pressure is not higher than the external liquid pressure by 0.5 bar, but allows the fluids inside the inner compartment to flow out when the inner compartment pressure is higher than the external liquid pressure by 1 bar.

4. The reference electrode of claim 1, wherein the inner compartment for housing the internal electrolyte is formed with a flexible tube that allows the pressure inside the inner compartment to be equal to the pressure outside the inner compartment except for the time when the high-pressure vessel is suddenly depressurized.

5. The reference electrode of claim 1, wherein the inner compartment for housing the internal electrolyte is formed with a rigid tube.

6. A reference electrode of claim 1, wherein an inlet to the inner compartment is added for using a high-pressure metering pump to continuously introduce fresh internal electrolyte so that the high-pressure gas(es) in the external liquid cannot enter the inner compartment to cause damage to the reference electrode.

7. A reference electrode for high-pressure applications, comprising:
(a) an inner compartment for housing an internal electrolyte and a metal conductor connected to a reference material at the bottom;
(b) a high-pressure probe body connected to a high-pressure vessel filled with an external liquid which may contain a high-pressure gas or a mixture of gases that can get into the inner compartment by diffusion.
(c) seals at the top of the inner compartment that seal the internal electrolyte and the reference material inside the inner compartment and allow the metal conductor to penetrate a high-pressure fitting on top of the reference electrode's high-pressure probe body for electrical connection;
(d) a porous liquid-junction plug sealed to the bottom of the inner compartment wherein the plug forms an ionic conducting path between the internal electrolyte and the external liquid in which the reference electrode is immersed;
(e) a pressure-relief port on the wall of the inner compartment and the pressure-relief port is surrounded by the external liquid;
(f) a volume-expandable second compartment that is inter-connected with the inner compartment through the pressure-relief port of the inner compartment
wherein the second compartment holds the internal electrolyte that flows out of the inner compartment, through the pressure-relief port, when the pressure of the inner compartment is higher than the pressure of the external liquid to prevent the mixing of the internal electrolyte with the external liquid.

8. The reference electrode of claim 7, wherein the second compartment is comprised of an elastic material that shrinks when the pressure difference between the inner compartment and the external liquid is less than 1 to 10 bar to keep the majority of the internal electrolyte in the inner compartment, and also expands when the pressure difference is higher than 1 to 10 bar.

9. The reference electrode of claim 7, wherein the second compartment is made of foldable material that expands like a sack and holds all the fluids from the inner compartment when the pressure of the inner compartment is higher than the pressure of the external liquid.

10. The reference electrode of claim 7, wherein the inner compartment for housing the internal electrolyte is formed with a flexible tube.

11. The reference electrode of claim 7, wherein the inner compartment for housing the internal electrolyte is formed with a rigid tube.

12. A reference electrode of claim 7, wherein an inlet to the inner compartment is added for using a high-pressure metering pump to continuously introduce fresh internal electrolyte so that the high-pressure gas(es) in the external liquid cannot enter the inner compartment to cause damage to the reference electrode.
